(19) United States
(12) Patent Application Publication
(10) Pub. No.: US 2026/0175456 A1
(43) Pub. Date: Jun. 25, 2026

(54) METHOD AND SYSTEM FOR DETERMINING A PATH FOR PROCESSING A WORKPIECE

(71) Applicant: ABB SCHWEIZ AG, Baden (CH)

(72) Inventors: Chen Li, Jiangsu (CN); Yiming Dong, Shanghai (CN); Zheng Ju, Shanghai (CN); Jizhou Xie, Shanghai (CN); Qi Lu, Shanghai (CN)

(21) Appl. No.: 19/461,133

(22) Filed: Jan. 27, 2026

Related U.S. Application Data
(63) Continuation of application No. PCT/CN2023/109945, filed on Jul. 28, 2023.

(51) Int. Cl. B25J 19/06

(52) U.S. Cl. CPC B25J 19/06

(57) ABSTRACT

A method and a system for determining a path for processing a workpiece include causing a manipulator of an industrial robot to present a plurality of different postures; causing a 3D sensor mounted on the manipulator to capture point cloud data of the workpiece when the manipulator presents the respective different postures, one of the workpiece and the 3D sensor being mounted on the manipulator, the other of the workpiece and the 3D sensor being placed on a worktable; stitching the acquired point cloud data for the plurality of posture; and generating, based at least in part on the stitched point cloud data, the path for processing a workpiece.

### FIELD

Embodiments of the present disclosure generally relate to an industrial robot and in particular to a method and a system for determining a path for processing a workpiece by the industrial robot.

### BACKGROUND

With repaid development of industrial automation, industrial robots are increasingly used in a manufacturing industry. Due to movement flexibility and mobility, multi-axis industrial robots are widely used in components processing, such as machining, assembling, welding, and the like. Multi-axis industrial robots typically comprise a manipulator formed by a plurality of axial joints. An end effector may be fixed to an end flange of the manipulator. Once a path for moving end effector is programmed, the manipulator is controlled to move along the programmed path to achieve various processing tasks.

Conventionally, the industrial robots are used for processing rigid parts, such as steel component. For these components, once the components are manufactured, one component is substantially the same as the other component. Thus, a path programmed, for example, via a teaching method, is universal for each component and would not incur problems during processing. However, there is an increasing need for further processing components of different material types (such as a plastic material) and/or a component more complex geometry (for example with a complex structures formed by thin walls) by the industrial robots. When the industrial robots are designed to process these components, many problems occur. One main issue is that these components tend be deformed to deviate from their designed dimensions. This means that geometry dimension of one component is different from that of another component. Thus, the universal path for processing all components programmed by the conventional teaching method cannot be used any more. There is a need to improve the path programming method in the state of the art.

### SUMMARY

Example embodiments of the present disclosure provide a method and a system for determining a path for processing a workpiece which can process the workpiece with high precision.

In a first aspect of the present disclosure, there is provided a method for determining a path for processing a workpiece. The method comprises: causing a manipulator of an industrial robot to present a plurality of different postures; causing a 3D sensor to capture point cloud data of the workpiece when the manipulator presents the respective different postures, one of the workpiece and the 3D sensor being mounted on the manipulator, the other of the workpiece and the 3D sensor being placed on a worktable; stitching the acquired point cloud data for the plurality of posture; and generating, based at least in part on the stitched point cloud data, the path for processing a workpiece. With this method, the 3D sensor is configured to capture point cloud data of the workpiece from different postures, the generated path is of high accuracy.

In some embodiments, the method may further comprise: calibrating position data of the manipulator for the plurality of postures; and acquiring configuration parameters of the manipulator for the plurality of postures. With this method, the system errors caused by the manipulator can be compensated. Thus, the position of the manipulator for the plurality of postures can be precisely calibrated.

In some embodiments, causing the manipulator of the industrial robot to present the plurality of different postures may comprise causing the manipulator to present the plurality of different postures based on the acquired configuration parameters.

In some embodiments, calibrating the position data of the manipulator may comprise: causing a 2D camera mounted on the manipulator to present the plurality of postures; causing the 2D camera to capture an image of a vision marker for the plurality of postures, the vision marker being stationary with respect to the worktable; and acquiring, based on the captured images, position data of the 2D camera for the plurality of postures the configuration parameters of the manipulator for the plurality of postures. By the 2D camera and the vision marker, the position of the manipulator can be calibrated with lower costs and high efficiency.

In some embodiments, calibrating the position data of the manipulator may comprise: causing a vision marker mounted on the manipulator to present the plurality of postures; causing a 2D camera to capture an image of the vision marker for the plurality of postures, the 2D camera being stationary with respect to the worktable; and acquiring, based on the captured images, position data of the 2D camera with respect to the vision marker for the plurality of postures and the configuration parameters of the manipulator for the plurality of postures. By the 2D camera and the vision marker, the position of the manipulator can be calibrated with lower costs and high efficiency.

In some embodiments, stitching the acquired point cloud data for the plurality of posture may comprise determining, based on the position data of the 2D camera with respect to the vision marker, registration parameters for stitching the acquired point cloud data; and stitching, based on the registration parameters, the acquired point cloud data. In this way, the point cloud data for the plurality of posture can be stitched with high accuracy.

In some embodiments, generating the path for processing the workpiece may comprise acquiring point cloud data of a workpiece model corresponding to the workpiece; generating, based on the stitched point cloud data of the workpiece and the point cloud data of the workpiece model, the path for processing the workpiece. In this way, the path can be generated with improved accuracy.

In some embodiments, generating the path for processing the workpiece may comprise: acquiring, based on the point cloud data of the workpiece model, a first path for processing the workpiece; applying non-rigid registration on the point cloud data of the workpiece model and the stitched point cloud data of the workpiece; determining an offset between the point cloud data of the workpiece model and the point cloud data of the workpiece after the non-rigid registration; and generating, based on the first path and the offset, the path for processing the workpiece. In this way, global point cloud data are used for path generation.

In some embodiments, generating the path for processing the workpiece may comprise: dividing the point cloud data of the workpiece model into a plurality of first feature regions; acquiring first point cloud data in the plurality of first feature regions; dividing the point cloud data of the workpiece into a plurality of second feature regions corresponding to the plurality of first feature regions; acquiring second point cloud data in the plurality of second feature regions; determining an offset between the first point cloud data and the second point cloud data; and generating, based at least in part on the offset, the path for processing the workpiece. In this way, partial point cloud data are used for path generation, with increased calculating efficiency and with reduced hardware costs.

In some embodiments, generating the path for processing the workpiece may further comprise: acquiring first feature points for processing the workpiece for the plurality of first feature regions; generating, based on the first feature point, the first path; and generating, based on the offset and the first path, the path for processing the workpiece. In this way, the path can be generated based on feature points.

In some embodiments, the first feature region may be a cross-section of the workpiece model, and the second feature region is a corresponding cross-section of the workpiece. In some embodiments, the first feature region may be a sub region of the workpiece model, and the second feature region is a corresponding sub region of the workpiece.

In a second aspect of the present disclosure, there is provided a system for determining a path for processing a workpiece. The system comprises a measuring device comprising a 3D sensor configured to capture point cloud data of a workpiece, one of the 3D sensor and the workpiece being mounted on a manipulator of an industrial robot which is configured to present a plurality of different postures, the other of the 3D sensor and the workpiece being placed on a worktable; and a path generation apparatus configured to stitch the acquired point cloud data for the plurality of posture and to generate, based at least in part on the stitched point cloud data, the path for processing a workpiece.

In some embodiments, the system may further comprise a calibration apparatus configured to calibrate position data of the manipulator for the plurality of postures and to acquire configuration parameters of the manipulator for the plurality of postures.

In some embodiments, the manipulator may be configured to present the respective posture of the plurality of postures based on the acquired configuration parameters.

In some embodiments, the calibration apparatus may comprise a 2D camera mounted on the manipulator and a vision marker being stationary with respect to the worktable, the 2D camera is caused to capture an image of the vision marker when the manipulator presents the plurality of postures, and the path generation apparatus is configured to acquire, based on the captured images, position data of the 2D camera with respect to the vision marker for the plurality of postures and the configuration parameters of the manipulator for the plurality of postures.

In some embodiments, the calibration apparatus may comprise a 2D camera being stationary with respect to the worktable, and a vision marker being mounted on the manipulator, the 2D camera is caused to capture an image of the vision marker when the manipulator presents the plurality of postures, and the path generation apparatus is configured to acquire, based on the captured images, position data of the 2D camera with respect to the vision marker for the plurality of postures and the configuration parameters of the manipulator for the plurality of postures.

In some embodiments, the path generation apparatus may be configured to: determine, based on the position data of the 2D camera with respect to the vision marker, registration parameters for stitching the acquired point cloud data; and stitch, based on the registration parameters, the acquired point cloud data.

In some embodiments, the system may further comprise an input apparatus configured to acquire point cloud data of a workpiece model corresponding to the workpiece, wherein the path generation apparatus is configured to generate, based on the stitched point cloud data of the workpiece and the point cloud data of the workpiece model, the path for processing the workpiece.

In some embodiments, the path generation apparatus may be further configured to: acquire, based on the point cloud data of the workpiece model, a first path for processing the workpiece; apply non-rigid registration on the point cloud data of the workpiece model and the stitched point cloud data of the workpiece; determine an offset between the point cloud data of the workpiece model and the point cloud data of the workpiece after the non-rigid registration; generate, based on the first path and the offset, the path for processing the workpiece.

In some embodiments, the path generation apparatus may be further configured to: divide the point cloud data of the workpiece model into a plurality of first feature regions; acquire first point cloud data in the plurality of first feature regions; divide the point cloud data of the workpiece into a plurality of second feature regions corresponding to the plurality of first feature regions; acquire second point cloud data in the plurality of second feature regions; determine an offset between the first point cloud data and the second point cloud data; and generate, based at least in part on the offset, the path for processing the workpiece.

In some embodiments, the path generation apparatus may be further configured to: acquire first feature points for processing the workpiece for the plurality of first feature regions; generate, based on the first feature point, the first path; and generate, based on the offset and the first path, the path for processing the workpiece.

In a third aspect of the present disclosure, there is provided an industrial robot. The industrial robot comprises a manipulator, and a controller configured to control the manipulator to process a workpiece along a path generated by a method according to a first aspect.

In a fourth aspect of the present disclosure, there is provided a computer program product tangibly stored on a non-transient computer readable medium, comprising a computer program when executed by a processor, causing the processor to perform a method according to a first aspect.

It would be appreciated that this summary is not intended to identify key features or essential features of embodiments of the present disclosure, nor is it intended to be used to limit the scope of the present disclosure. Other features of the present disclosure will become evident through the following description.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is an overall schematic view of a system for determining a path for processing a workpiece by an industrial robot according to one example embodiment of the present disclosure;

FIGS. 2a and 2b show a perspective view of a workpiece model and a real workpiece to be processed by the industrial robot according to one example embodiment of the present disclosure respectively;

FIG. 3 is a flowchart of a method for determining a path for processing a workpiece by an industrial robot according to one example embodiment of the present disclosure;

FIG. 4 is overall schematic view of a system for calibrating the manipulator according to one example embodiment of the present disclosure;

FIG. 5 is a flowchart of a method for calibrating the manipulator according to one example embodiment of the present disclosure;

FIG. 6 is a flowchart of a method for determining a path for processing a workpiece by an industrial robot on according to one example embodiment of the present disclosure;

FIG. 7 is flowchart of a method for generating a path for processing a workpiece by an industrial robot on according to one example embodiment of the present disclosure;

FIG. 8 is flowchart of a method for generating a path for processing a workpiece by an industrial robot on according to one example embodiment of the present disclosure;

FIGS. 9a-9c shows a partial cross section of a workpiece model, the associated point cloud of the workpiece model and the associated point cloud of the real workpiece to be processed by the industrial robot according to one example embodiment of the present disclosure respectively; and

FIG. 10 is a block diagram of an example device 1000 adapted to implement the embodiments of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

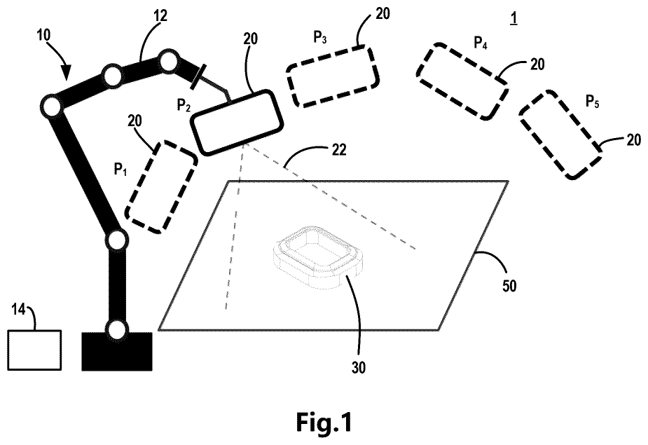

FIG. 1 is an overall schematic view of a system 1 for determining a path for processing a workpiece by an industrial robot 10 according to one example embodiment of the present disclosure. As shown in FIG. 1, the system may include one or more industrial robots 10. The industrial robot 10 may include a manipulator (also called as a robotic arm) 12 formed by a plurality of axial joints and one or more arms connecting the joints. A working area for the industrial robot 10 can be defined via lengthwise arms. It is to be understood that in the shown example merely one industrial robot 10 is shown, the number of the industrial robot 10 may be any other number. It is to be understood that the shown industrial robot 10 is merely illustrative and the industrial robot 10 may be implemented as any other forms. In the following description, the industrial robot 10 is described as not only generating the path for processing a workpiece but also processing the workpiece based on the generated path. This is merely illustrative. It is to be understood that the industrial robot for processing the workpiece may not necessarily be the industrial robot for generating the path. In some embodiments, the industrial robot for processing the workpiece may be the same as the industrial robot for generating the path. In some embodiments, the industrial robot for processing the workpiece may be different from the industrial robot for generating the path.

As shown in FIG. 1, the system 1 may include a worktable 50 configured to support a workpiece 30 to be processed. The workpiece 30 is located in the working area of the industrial robot 10 and thus can be accessed for example, by a tool (not shown) mounted on the end flange of the manipulator. The worktable 50 may be of various forms, for example, a rotary or a liner conveyer, a stationary work platform, and the like.

In some embodiments, the workpiece 30 may be a blank piece or a semi-finished piece produced by injection molding, casting, or other methods. The industrial robot 10 is configured to process (e.g., cut, polish, paint, and the like) a predetermined area or a portion of the workpiece. In some embodiments, the workpiece may be a part constituting a larger component. The industrial robot is configured to, for example, spray adhesive onto the workpiece at a predetermine area so that the sprayed workpiece can be attached to another workpiece via gluing in a subsequent process. In some embodiments, the workpiece 30 may be two pre-assembled parts. The industrial robot is configured to perform welding or thermal fusion along a predetermined line or a predetermined area so as to connect the two pre-assembled parts into one piece. It is to be understood that the above shown applications are merely illustrative, and the industrial robot 10 may be used to perform any other processing tasks.

All these applications require the industrial robot 10 to process the workpiece with high precision such that the predetermined area of the workpiece can be processed properly. Accordingly, the industrial robot 10 is designed to move the manipulator along a path with high precision. Conventionally, the path is generated by various teaching methods as known in the art. However, the conventional path generating method is not satisfactory since the precision of the manipulator cannot meet requirements of the above tasks due to reasons for example as mentioned in background part of the present disclosure. In particular, in many circumferences, a workpiece to be processed by the industrial robot may be subject to a certain degree of deformation during its initial manufacturing, which results in deviation of its dimension and/or profile from its design model. For example, when the workpiece comprises a structure formed by a thin wall or is made of a flexible material, such as a rubber, a plastic material, and the like, the thin wall of the real workpiece is likely to be deformed and the industrial robot cannot process these workpieces with high precision when the industrial robot is programmed by the conventional path generating method.

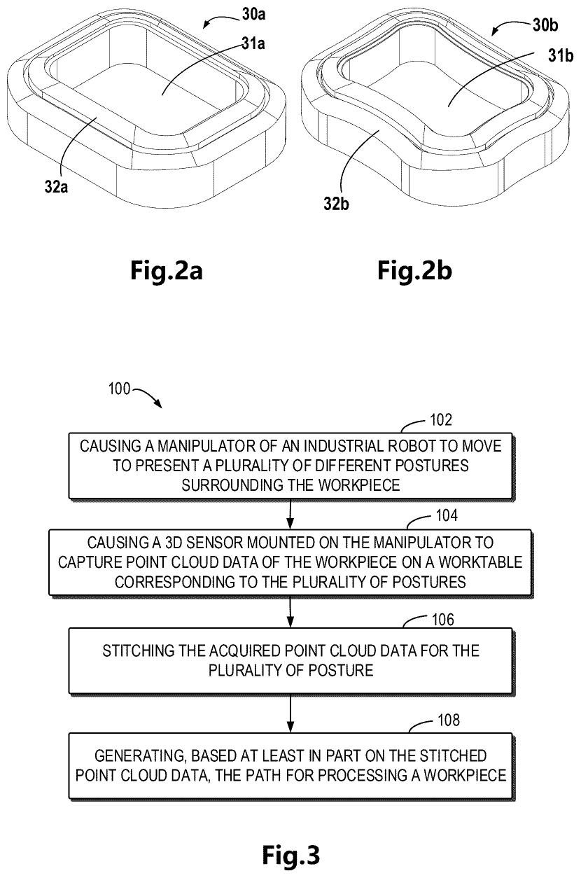

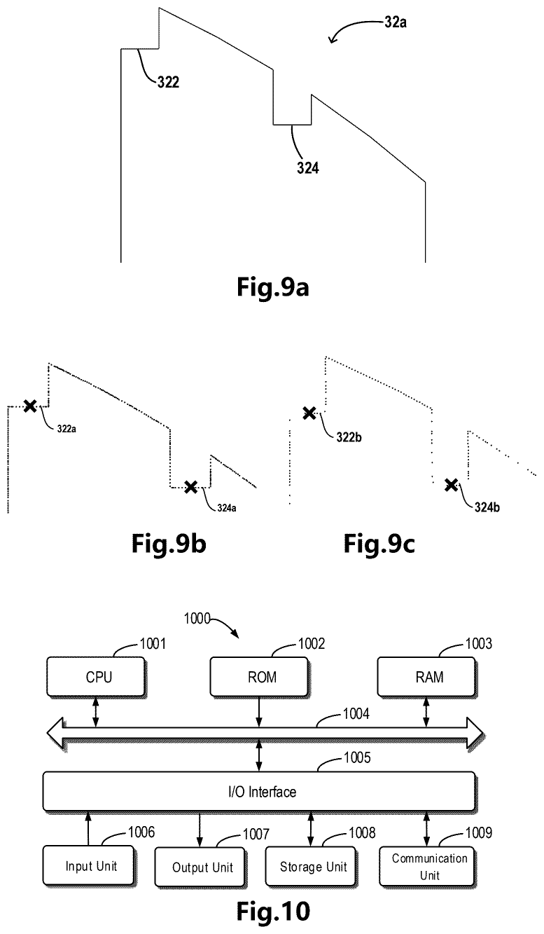

As shown in FIGS. 2a and 2b which show a perspective view of a workpiece model and a real workpiece to be processed respectively. The left figure on the page shows a workpiece model 30a. The workpiece model 30a include a chamber 31a surrounded by circumferential side walls 32a. The circumferential side walls 32a are made of a thin wall and comprise a complex structure including two grooves (also referring to FIG. 9a). As shown, the lengthwise side wall 32a of the workpiece model 30a is straight. When a workpiece model is produced or assembled, a real workpiece may be subject to deformation. The right figure on the page shows the real workpiece 30b produced in accordance with the workpiece model 30a. The workpiece 30b is substantially the same as the workpiece model 30a and include a chamber 31b defined by circumferential side walls 32b. As shown, the lengthwise side wall 32b of the real workpiece 30b is more or less curved due to forces applied thereto during the manufacturing step. When the industrial robot is configured to move the manipulator along a path generated by the conventional teaching method according to the workpiece model 30a, the real workpiece 30b cannot be properly processed by the industrial robot. That is because the real workpiece 30b is more or less different from each other, and position accuracy of the path generated by the conventional teaching method according to the workpiece model 30a is not sufficient to process each of the real workpiece 30b by the industrial robot. That means, there is no uniform path for processing all the workpieces 30b produced in accordance with one design model. Rather, the path for processing this kind of workpieces should be workpiece-dependent. According to the present disclosure, a novel system and a novel method are provided and are configured to determine a path for moving the manipulator in accordance with real workpiece to be processed by the industrial robot.

Turning back to FIG. 1, according to the present disclosure, the system 1 include a measuring device which is configured to measure profile data of the workpiece 30 to be processed and a path generation apparatus 14 which is configured to generate a path for processing the workpiece 30 based on the measured profile data of the workpiece 30. The measuring device is mounted on the manipulator 12 of the industrial robot. The measuring device includes one or more 3D sensors 20 configured to obtain 3D point could data of the workpiece 30. When a path generated based on the 3D point could data, the path can ensure sufficient accuracy for processing the workpiece 30. The 3D sensors 20 may be of various types, for example, a binocular sensor, a structured light sensor, a ToF sensor, a LiDAR sensor, and the like.

Although the 3D sensor has advantages in obtaining 3D data of the workpiece 30, the 3D sensor is subject to disadvantages for example, with narrow view filed as shown by reference sign 22 in dashed lines. In order to obtain a complete image of the workpiece 30, a number of 3D sensors are needed to be arranged around the workpiece. But providing a number of 3D sensors around the workpiece 30 is costly. When there are a number of industrial robots, the costs are dramatically increased when each industrial robot is furnished with a plurality of 3D sensors. According to the present disclosure, by providing a movable 3D sensor 20, the number required for imaging the workpiece 30 is reduced to one and the costs can be dramatically reduced. By the 3D sensor 20 being mounted to the manipulator 12 and being moved by the manipulator 12, the 3D sensor 20 can sense the workpiece 30 from different orientations around the workpiece 30 as the manipulator moves.

As shown in FIG. 1, five postures P1, P2, P3, P4, P5 are shown. These postures are set in advance for example according to the form of the workpiece. In FIG. 1, the position P2 is shown in solid line while the others P1, P3, P4, P5 are shown by dashed line. It is to be understood that the number of the postures are merely illustrative. In some embodiments, there may be tens or hundreds of postures that the 3D sensor 30 may assume according to areas to be processed of the workpiece 30. These postures are arranged to surround the workpiece 30 and a full coverage of the workpiece 30, or at least a coverage of the part to be processed, can be realized. This means that the profile and the dimensions of workpiece can be reliably determined based on the captured images or point cloud. The 3D sensor may be disposed adjacent to the tool, for example, on the same bracket for supporting the tool, or on a separate bracket different from that for supporting the tool. The bracket may be mounted to the end flange of the manipulator and moves as the manipulator moves.

The path generation apparatus 14 is a computing device that is configured to perform calculations. After the point cloud data for the plurality of postures, the acquired point cloud data for the plurality of posture are stitched together by the path generation apparatus 14. The path for processing the workpiece 30 can then be generated based on the stitched point cloud data. In the shown example, the path generation apparatus 14 is shown to be a separate device from a controller of the industrial robot 10. It is to be understood that the path generation apparatus 14 may be integrated into the controller of the industrial robot 10.

In the shown example, the workpiece is placed on the worktable. The 3D sensor is mounted on the manipulator and is movable with respect to the workpiece. It is to be understood that the above arrangement is merely illustrative. In some embodiments, the 3D sensor is placed on the worktable. The workpiece is mounted on the manipulator and is movable with respect to the 3D sensor. With this arrangement, the method can be analogously implemented according to the present disclosure.

FIG. 3 shows a flowchart of a method 100 for determining a path for processing a workpiece by an industrial robot according to one example embodiment of the present disclosure. At a block 102, a manipulator 12 of an industrial robot 10 is caused to move to present a plurality of different postures. Also referring to FIG. 1, after the workpiece 30 is placed on the worktable 50, the industrial robot 10 is controlled to move the manipulator 12 to present the plurality of postures P1-P5 respectively. The number of postures and the orientations in each posture can be determined in advance, for example, according to the shape and the dimensions of the workpiece 30. At a block 104, a 3D sensor 20 is caused to capture point cloud data of the workpiece 30 from the respective postures. At each posture as shown in FIG. 1, the 3D sensor 20 is configured to capture point cloud data of the workpiece 30 from the respective orientation. At a block 106, the point cloud data acquired at the respective posture for the plurality of posture are stitched together. At a block 108, the path for processing a workpiece 30 is generated based at least in part on the stitched point cloud data. A path for processing the workpiece 30 thus is generated based on the stitched point cloud data.

In accordance with the present disclosure, since the generated path is workpiece-dependent, the position accuracy of the generated path can be ensured. After the path for processing the workpiece 30 is generated, the industrial robot 10 is instructed to move the manipulator in accordance with the generated path. In this way, even if the dimension of one workpiece is different from another workpiece, since the generated path is workpiece-dependent, the workpiece can be processed with high precision.

In some embodiments, the system 1 may include a calibrating apparatus configured to calibrate the position of the manipulator 12 when the manipulator 12 is located at the respective posture of the plurality of postures. Before the 3D sensor 20 acquiring the point cloud data of the workpiece 30, for the respective postures, position data of the manipulator 12 are calibrated by the calculating apparatus. This is beneficial when a movement precision of the manipulator is low. As known, the manipulator typically consists of a plurality of axes. Due to a systemic error of the industrial robot 20, position precision of the end effector may not be sufficient. This may result in a poor precision when multi view point cloud data are stitched together using a registration technology. That is because, when the acquired point cloud data for the plurality of posture are stitched together, the path generation apparatus 14 relies on the precision position of the 3D sensor 20. If the precision position of the 3D sensor 20 is not sufficient, the stitched point cloud data results in lower precision which is not desired.

In some embodiments, position data of the manipulator 12 may be calibrated by the calibrating apparatus. Configuration parameters of the manipulator 12 are acquired when the manipulator 12 is at the respective posture. The manipulator 12 is configured to be moved to present the respective posture based on the acquired configuration parameters. In some embodiments, position data of the manipulator 12 may be calibrated by using the 3D sensor. For example, this method may be implemented with the 3D sensor in combination with a calibration target with simple geometry. By capturing point cloud of the calibration target with the 3D sensor, the position data of the manipulator 12 for each posture can be determined.

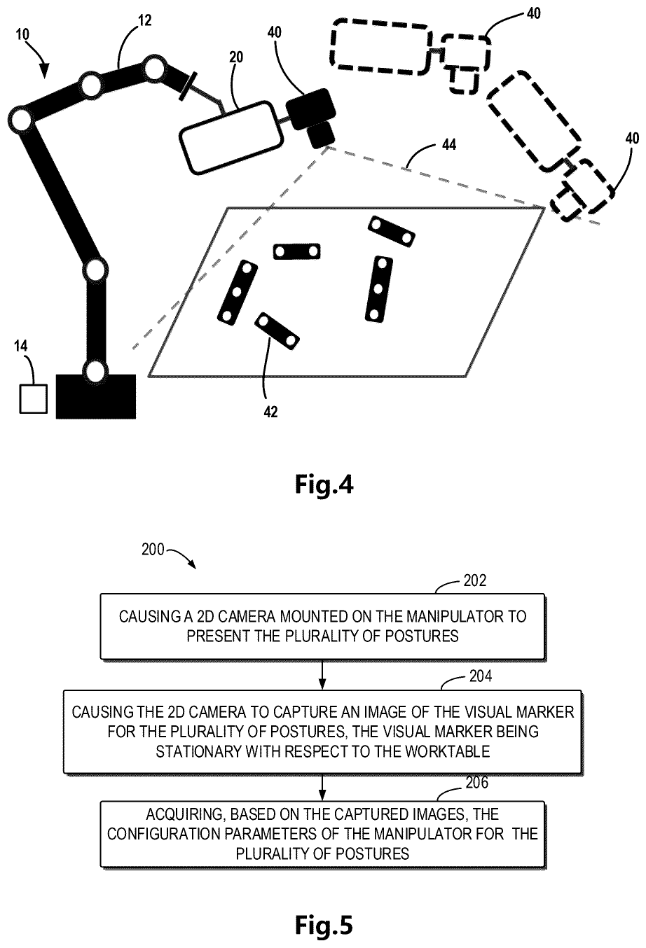

FIG. 4 is overall schematic view of a system for calibrating the manipulator 12 before a 3D sensor acquiring the point cloud data of the workpiece 30 according to one example embodiment of the present disclosure. As shown in FIG. 4, the calibration apparatus may include a 2D camera 40 and a vision marker 42. Compared to the 3D sensor 20, the 2D camera 40 include a much larger field view 44 than the filed view 22 of the 3D sensor 20 (referring to FIG. 2). Thus, the 2D camera can realize a large coverage of the work area of the industrial robot. The 2D camera 40 may be mounted to the manipulator 12. In the shown example, the 2D camera 40 may be attached to the end flange of the manipulator adjacent to the 3D sensor 20. The 2D camera 40 and the 3D sensor may be mounted on the same bracket which is further attached to the end flange of the manipulator. In some other embodiments, during the calibration process, the 3D sensor 20 may be removed from the bracket.

The vision marker 42 may be placed on the worktable 50 and is stationary with respect to the worktable 50. In the shown example, the vision marker 42 includes a plurality of markers. It is to be understood that the shown example is merely illustrative and the vision marker 42 may be of any other proper forms (for example, a checkboard) as long as the position of the 2D camera 40 can be precisely calibrated.

When the manipulator 12 is moved to present the plurality of postures, the 2D camera 40 is caused to capture an image of the vision marker 42 at the respective posture. The position of the 2D camera 40 can be determined based on the captured image. Corresponding configuration parameters of the manipulator 12 for the plurality of postures can also be recorded. The manipulator 12 is configured to be moved to present the respective posture based on the recorded configuration parameters.

In addition, since the position relationship between the 2D camera 40 and the end flange of the manipulator is fixed, the position of the end flange of the manipulator is also known. Thus, the position of the 3D sensor can also be known and this position data can be used for registration parameters for stitching the point cloud data obtained by the 3D sensor during the subsequent measuring process.

In the shown example, the 2D camera 40 is mounted to the manipulator 12 and is configured as a movable component while the vision marker 42 is fixed with respect to the worktable 50. In some other embodiments (not shown), the vision marker 42 is mounted to the manipulator 12 and is configured as a movable component while the 2D camera 40 is fixed with respect to the worktable 50. The manipulator can be analogously calibrated and their description is omitted.

FIG. 5 is a flowchart of a method 200 for calibrating the manipulator according to one example embodiment of the present disclosure. At a block 202, a 2D camera 40 mounted on the manipulator 12 is caused to move to present the plurality of postures. This can be realized by controlling the manipulator 12 based on instructions from the controller of the industrial robot. At a block 204, the 2D camera 40 is caused to capture an image of the vision marker 42 at the respective posture for the plurality of postures. When the 2D camera 40 presents the respective predetermined posture, the 2D camera 40 is instructed to capture an image of the vision marker. At a block 206, position data of the 2D camera with respect to the vision marker and configuration parameters of the manipulator 12 for the plurality of postures are acquired based on the captured images. These configuration parameters of the manipulator 12 can be recorded and are used as calibration data for moving the manipulator in the subsequent step of measuring the point cloud of the workpiece.

The above example method is applicable to the case that the 2D camera 40 is mounted to the manipulator 12 and is configured as a movable component while the vision marker 42 is fixed with respect to the worktable 50. As for the case that the vision marker 42 is mounted to the manipulator 12 and is configured as a movable component while the 2D camera 40 is fixed with respect to the worktable 50, the method is analogues and their description is omitted.

According to the present disclosure, since the position data of the manipulator 12 for the plurality of the predetermined postures for measuring point cloud of the workpiece 30 is calibrated, the position accuracy of the manipulator 12 is not limited by the system accuracy error caused by the transmission chain of the multi-axis of the industrial robot can be eliminated. Thus, the position accuracy for the manipulator 12 in the plurality of the predetermined postures is ensured.

After calibration of the manipulator, the position data of the 2D camera with respect to the vision marker for the plurality of postures may be used as registration parameters for stitching the acquired point cloud data. The precision position of the 3D sensor is necessary for registering the plurality of point cloud data obtained by the 3D sensor for each of the plurality of postures. For example, the position data of the 2D camera with respect to the vision marker for each of the plurality of postures may be recorded in a memory during the calibration process. Registration parameters for stitching the acquired point cloud data can be determined based on the acquired calibration position data. The plurality of point cloud data obtained by the 3D sensor for the plurality of postures can thus be stitched together based on the registration parameters. Due to the high precision of position data of the manipulator 12, the plurality of point cloud data can be registered with high precision.

In some embodiments, information related to the workpiece model may be needed when the path for processing the workpiece 30 is generated. In particular, when the workpiece 30 includes a complex configuration, for example, including deformable thin walls, deep grooves, high reflective surfaces, and the like, the workpiece model may facilitate path generation. The term “workpiece model” refers to a standard model or a prototype of the product while the term “the workpiece” refers to a real workpiece produced via various producing methods.

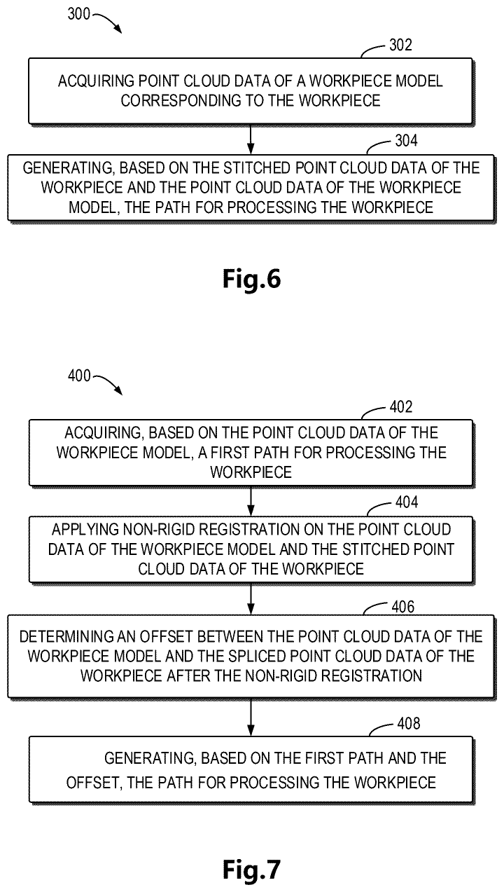

FIG. 6 is a flowchart of a method 300 for determining a path for processing a workpiece by an industrial robot on according to one example embodiment of the present disclosure. At a block 302, point cloud data of a workpiece model is acquired. The workpiece model, for example, a CAD model, may be input to the path generation apparatus via a user interface. Point cloud data of the workpiece model may be obtained from the CAD model. The point cloud data of the workpiece model include actuate dimension information of the workpiece model. These point cloud data may be used as reference point cloud for processing the measured point cloud data obtained by the 3D sensor. At a block 304, the path for processing the workpiece 30 is generated based on the stitched point cloud data of the workpiece 30 and the point cloud data of the workpiece model. Since the point cloud data of the workpiece model include actuate dimension information of the workpiece model, a base path may be identified in the point cloud data of the workpiece model. The stitched point cloud data of the workpiece 30 may be processed to compensate the deviation caused for example by material deformation of the workpiece material. An offset can be determined, for example, by comparing the point cloud data of the workpiece model and the stitched point cloud data of the workpiece 30. The offset may be used to correct the base path. Thus, the path for processing the workpiece can be corrected.

There are a number of ways for path generation based on the stitched point cloud data of the workpiece 30 and the point cloud data of the workpiece model. In some embodiments, global point cloud data are used for path generation. That is, all point cloud data that related to the path generation are extracted from the point cloud data of the workpiece model and the stitched point cloud data and all used for path generation. This may be beneficial in improving accuracy of the path since all point cloud data that related to the path generation are considered in path generation. But this also requires high computing power, which means high hardware costs. In some embodiments, merely partial point cloud data are used for path generation. That is, not all point cloud data that related to the path generation are extracted from the point cloud data of the workpiece model and the stitched point cloud data. This may be beneficial in improving efficacy of path generation, with reduced hardware costs.

FIG. 7 is flowchart of a method 400 for generating a path for processing a workpiece using global point cloud data. At a block 402, a first path for processing the workpiece 30 is acquired based on the point cloud data of the workpiece model. This path may be preset by the user by providing featuring points in accordance with the requirements of the model. For example, in one example, when the workpiece 30 to be processed is a plastic component formed via injection molding. A part of the workpiece 30 needs to be removed. A plurality of feature points may be provided and are used for identifying the part to be removed. The plurality of feature points may thus form the first path.

At a block 404, non-rigid registration is applied on the point cloud data of the workpiece model and the stitched point cloud data of the workpiece 30. Various non-rigid registration algorithms may be used. With the non-rigid registration, a mapping between two sets of point cloud can be created. At a block 406, an offset between the point cloud data of the workpiece model and the point cloud data of the workpiece 30 may be determined. This offset may indicate the deviation between the real workpieces and the workpiece model. At a block 408, the path for processing the workpiece 30 is generated based on the first path and the offset. By using the offset, the deviation of the real workpieces from the workpiece model can be compensated.

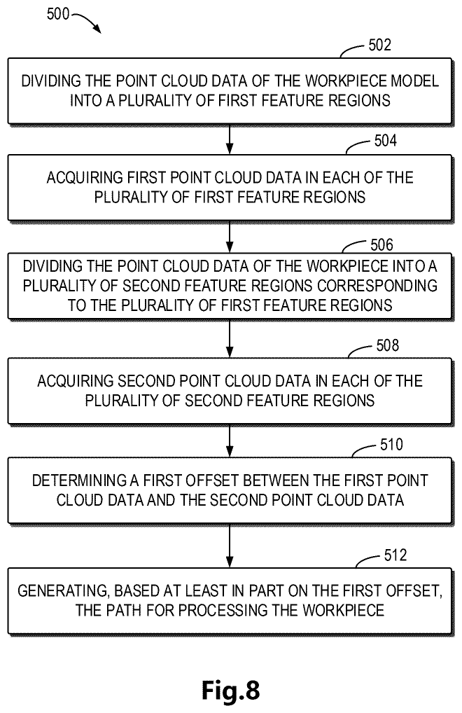

FIG. 8 is flowchart of a method 500 for generating a path for processing a workpiece using partial point cloud data. At a block 502, the point cloud data of the workpiece model is divided into a plurality of first feature regions. The term “feature regions” herein refers to a sub point cloud dataset of the complete point cloud dataset which includes all related point cloud data that are used to identify the path to be formed. The feature region may include various forms. In some example, the feature region may include a sub region of a predetermined shape (for example, a box shape). The point cloud data within the sub region are extracted for path generation while the other cloud data outside the sub region are not used for data extraction. In some example, the feature region may include a cross section of the workpiece. It is to be understood that the feature region may be of any other proper forms. The feature regions may be set by the user in advance. At a block 504, first point cloud data in each of the plurality of first feature regions are acquired. The first point cloud data identifying the feature points are extracted for each of the plurality of first feature regions.

The point cloud data of the workpiece may be analogously obtained. At a block 506, the point cloud data of the workpiece 30 are divided into a plurality of second feature regions corresponding to the plurality of first feature regions. At a block 508, second point cloud data in each of the plurality of second feature regions are acquired. At a block 510, an offset between the first point cloud data and the second point cloud data is determined. By comparing the first point cloud data and the second point cloud data, the offset between two sets of point cloud can be determined. At a block 512, the path for processing the workpiece 30 is generated based on the offset. According to this embodiment, since merely partial point cloud data are used for path generation, efficacy of path generation can be improved. This is applicable to the case that the workpiece is processed in real time. The path should be generated in real time and then the workpiece is processed based on the generated path in real time.

In some embodiments, first feature points for processing the workpiece may be obtained for each of the plurality of first feature regions. The first path is generated based on the first feature point. The path for processing the workpiece is generated based on the offset and the first path.

FIGS. 9a-9c show a method of how to generate a path for processing a workpiece using partial point cloud data at a cross section. The point cloud data of the workpiece may be divided into a number of cross sections, for example, tens, hundreds, or thousands. FIG. 9a shows one cross section of a circumferential side wall 32a of a workpiece model 31a shown in FIG. 2a. As shown in FIG. 9a, the circumferential side wall 32a comprises two grooves 322a and 324a.

As shown in FIGS. 9a and 9b, the cross section of one circumferential side wall is used as the feature region for path generation. FIG. 9b shows the associated point cloud of the workpiece model at the cross section obtained, for example, from the CAD model. Two signs “X” are provided at the center point of each groove 322a, 324a and are used to identify the feature points in the workpiece model. As an example, an area between the two signs “X” may define a processing area which is to be processed by the tool mounted on the manipulator. FIG. 9c shows the associated point cloud of the real workpiece at the corresponding cross section obtained, for example, from the 3D sensor. Two signs “X” are indicated at the center point of each groove 322b, 324b and are used to identify the feature points in the workpiece corresponding to the first feature points in the workpiece model. For each sign “X” at the respective groove, an offset there between can be obtained by comprising the two signs “X” provided at the center point of each groove 322a, 324a and the two signs “X” provided at the center point of each groove 322b, 324b. The positions of the two signs “X” provided at the center point of each groove 322b, 324b can thus be adjusted in accordance with the obtained offset. The adjusted two signs “X” thus are used to define the processing area to be processed by the industrial robot.

FIG. 10 illustrates a block diagram of an example device 1000 adapted to implement the embodiments of the present disclosure. As shown in the figure, a portion of the system in FIGS. 1 and 4 may be implemented by the device 1000. As shown in FIG. 10, the device 1000 comprises a central processing unit (CPU) 1001 that may perform various appropriate actions and processing based on computer program instructions stored in a read-only memory (ROM) 1002 or computer program instructions loaded from a memory unit 1008 to a random access memory (RAM) 1003. In the RAM 1003, various programs and data needed for operations of the device 1000 may also be stored. The CPU 1001, ROM 1002 and RAM 1003 are connected to each other via a bus 804. An input/output (I/O) interface 1005 is also connected to the bus 1004.

Various components in the device 1000 are connected to the I/O interface 1005, including: an input unit 1006 such as a keyboard, a mouse and the like; an output unit 1007 such as various kinds of displays and a loudspeaker, etc.; a storage unit 1008 such as a magnetic disk, an optical disk, and etc.; a communication unit 1009 such as a network card, a modem, and a wireless communication transceiver, etc. The communication unit 1009 allows the device 1000 to exchange information/data with other devices through a computer network such as the Internet and/or various kinds of telecommunications networks.

Various processes and processing described above, e.g., methods 100-500, may be executed by the processing unit 1001. For example, in some embodiments, the methods 100-400 may be implemented as a computer software program that is tangibly embodied on a machine readable medium, e.g., the storage unit 1008. In some embodiments, part or all of the computer program may be loaded and/or mounted onto the device 1000 via ROM 1002 and/or communication unit 1009. When the computer program is loaded to the RAM 1003 and executed by the CPU 1001, one or more steps of the method 100-500 as described above may be executed.

Embodiments of the present disclosure relate to a method, device, system and/or computer program product. The computer program product may include a computer readable storage medium on which computer readable program instructions for executing various aspects of the present disclosure are embodied.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/actions specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/actions specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, section, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or actions, or combinations of special purpose hardware and computer instructions.

The description of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for determining a path for processing a workpiece comprising:
causing a manipulator of an industrial robot to present a plurality of different postures;
causing a 3D sensor to capture point cloud data of the workpiece when the manipulator presents the respective different postures, one of the workpiece and the 3D sensor being mounted on the manipulator, the other of the workpiece and the 3D sensor being placed on a worktable;
stitching the acquired point cloud data for the plurality of posture; and
generating, based at least in part on the stitched point cloud data, the path for processing a workpiece

2. The method according to claim 1, further comprising:
calibrating position data of the manipulator for the plurality of postures; and
acquiring configuration parameters of the manipulator for the plurality of postures.

3. The method according to claim 2, wherein causing the manipulator of the industrial robot to present the plurality of different postures comprises causing the manipulator to present the plurality of different postures based on the acquired configuration parameters.

4. The method according to claim 2, wherein calibrating the position data of the manipulator comprises:
causing a 2D camera mounted on the manipulator to present the plurality of postures;
causing the 2D camera to capture an image of a vision marker for the plurality of postures, the vision marker being stationary with respect to the worktable; and
acquiring, based on the captured images, position data of the 2D camera with respect to the vision marker for the plurality of postures and the configuration parameters of the manipulator for the plurality of postures.

5. The method according to claim 2, wherein calibrating the position data of the manipulator comprises:
causing a vision marker mounted on the manipulator to present the plurality of postures;
causing a 2D camera to capture an image of the vision marker for the plurality of postures, the 2D camera being stationary with respect to the worktable; and
acquiring, based on the captured images, position data of the 2D camera with respect to the vision marker for the plurality of postures and the configuration parameters of the manipulator for the plurality of postures.

6. The method according to claim 4, wherein stitching the acquired point cloud data for the plurality of posture comprises:
determining, based on the position data of the 2D camera with respect to the vision marker, registration parameters for stitching the acquired point cloud data; and
stitching, based on the registration parameters, the acquired point cloud data.

7. The method according to claim 1, wherein generating the path for processing the workpiece comprises:
acquiring point cloud data of a workpiece model corresponding to the workpiece; and
generating, based on the stitched point cloud data of the workpiece and the point cloud data of the workpiece model, the path for processing the workpiece.

8. The method according to claim 7, wherein generating the path for processing the workpiece comprises:
acquiring, based on the point cloud data of the workpiece model, a first path for processing the workpiece;
applying non-rigid registration on the point cloud data of the workpiece model and the stitched point cloud data of the workpiece;
determining an offset between the point cloud data of the workpiece model and the point cloud data of the workpiece after the non-rigid registration; and
generating, based on the first path and the offset, the path for processing the workpiece.

9. The method according to claim 7, wherein generating the path for processing the workpiece comprises:
dividing the point cloud data of the workpiece model into a plurality of first feature regions;
acquiring first point cloud data in the plurality of first feature regions;
dividing the point cloud data of the workpiece into a plurality of second feature regions corresponding to the plurality of first feature regions;
acquiring second point cloud data in the plurality of second feature regions;
determining an offset between the first point cloud data and the second point cloud data; and
generating, based at least in part on the offset, the path for processing the workpiece.

10. The method according to claim 9, wherein generating the path for processing the workpiece further comprises:
acquiring first feature points for processing the workpiece for the plurality of first feature regions;
generating, based on the first feature point, the first path; and
generating, based on the offset and the first path, the path for processing the workpiece.

11. The method according to claim 9, wherein the first feature region is a cross-section of the workpiece model, and the second feature region is a corresponding cross-section of the workpiece.

12. The method according to claim 9, wherein the first feature region is a sub region of the workpiece model, and the second feature region is a corresponding sub region of the workpiece.

13. A system for determining a path for processing a workpiece comprising:
a measuring device comprising a 3D sensor configured to capture point cloud data of a workpiece, one of the 3D sensor and the workpiece being mounted on a manipulator of an industrial robot which is configured to present a plurality of different postures, the other of the 3D sensor and the workpiece being placed on a worktable; and
a path generation apparatus configured to stitch the acquired point cloud data for the plurality of posture and to generate, based at least in part on the stitched point cloud data, the path for processing a workpiece

14. The system according to claim 13, further comprising a calibration apparatus configured to calibrate position data of the manipulator for the plurality of postures and to acquire configuration parameters of the manipulator for the plurality of postures.

15. The system according to claim 14, wherein the manipulator is configured to present the respective posture of the plurality of postures based on the acquired configuration parameters.

16. The system according to claim 14, wherein the calibration apparatus comprises a 2D camera mounted on the manipulator and a vision marker being stationary with respect to the worktable,
the 2D camera is caused to capture an image of the vision marker when the manipulator presents the plurality of postures, and
the path generation apparatus is configured to acquire, based on the captured images, position data of the 2D camera with respect to the vision marker for the plurality of postures and the configuration parameters of the manipulator for the plurality of postures.

17. The system according to claim 14, wherein the calibration apparatus comprises a 2D camera being stationary with respect to the worktable, and a vision marker being mounted on the manipulator,
the 2D camera is caused to capture an image of the vision marker when the manipulator presents the plurality of postures, and
the path generation apparatus is configured to acquire, based on the captured images, position data of the 2D camera with respect to the vision marker for the plurality of postures and the configuration parameters of the manipulator for the plurality of postures.

18. The system according to claim 16, wherein the path generation apparatus is configured to:
determine, based on the position data of the 2D camera with respect to the vision marker, registration parameters for stitching the acquired point cloud data; and
stitch, based on the registration parameters, the acquired point cloud data.

19. The system according to claim 13, further comprising an input apparatus configured to acquire point cloud data of a workpiece model corresponding to the workpiece, wherein the path generation apparatus is configured to generate, based on the stitched point cloud data of the workpiece and the point cloud data of the workpiece model, the path for processing the workpiece.

20. The system according to claim 19, wherein the path generation apparatus is further configured to:
acquire, based on the point cloud data of the workpiece model, a first path for processing the workpiece;
apply non-rigid registration on the point cloud data of the workpiece model and the stitched point cloud data of the workpiece;
determine an offset between the point cloud data of the workpiece model and the point cloud data of the workpiece after the non-rigid registration; and
generate, based on the first path and the offset, the path for processing the workpiece.

21. The system according to claim 19, wherein the path generation apparatus is further configured to:
divide the point cloud data of the workpiece model into a plurality of first feature regions;
acquire first point cloud data in the plurality of first feature regions;
divide the point cloud data of the workpiece into a plurality of second feature regions corresponding to the plurality of first feature regions;
acquire second point cloud data in the plurality of second feature regions;
determine an offset between the first point cloud data and the second point cloud data; and
generate, based at least in part on the offset, the path for processing the workpiece.

22. The system according to claim 21, wherein the path generation apparatus is further configured to:
acquire first feature points for processing the workpiece for the plurality of first feature regions;
generate, based on the first feature point, the first path; and
generate, based on the offset and the first path, the path for processing the workpiece.

23. The system according to claim 21 wherein the first feature region is a cross-section of the workpiece model, and the second feature region is a corresponding cross-section of the workpiece.

24. The system according to claim 21, wherein the first feature region is a sub region of the workpiece model, and the second feature region is a corresponding sub region of the workpiece.

25. An industrial robot comprising:
a manipulator, and
a controller configured to control the manipulator to process a workpiece along a path generated by a method according to claim 1.

26. A computer program product tangibly stored on a non-transient computer readable medium, comprising a computer program when executed by a processor, causing the processor to perform a method according to claim 1.
